(19) United States
(12) Patent Application Publication
(10) Pub. No.: US 2017/0322356 A1
(43) Pub. Date: Nov. 9, 2017

(54) LIGHT SHIELDING STRUCTURE OF ELECTRONIC DEVICE

(71) Applicant: EVGA CORPORATION, New Taipei City (TW)

(72) Inventor: TAI-SHENG HAN, New Taipei City (TW)

(21) Appl. No.: 15/146,900

(22) Filed: May 5, 2016

(51) Int. Cl. G02B 5/22

(52) U.S. Cl. CPC G02B 5/22

(57) ABSTRACT

A light shielding structure is provided for an electronic device and includes a display device mounted to the electronic device, an outer casing arranged at one side of the display device, a light transmitting portion mounted on the outer casing, an adjustable light-shielding plate arranged between the display device and the light transmitting portion, and an adjusting device set on one side of the adjustable light-shielding plate and operatively coupled thereto. When the display device is activated, light transmits toward the adjustable light-shielding plate. When the adjustable light-shielding plate is in an idle and not operating condition, the light is allowed to transmit through the adjustable light-shielding plate and the light transmitting portion to make light projecting out from the outer casing. Oppositely, the adjusting device may be operated to cause the adjustable light-shielding plate to change color for shielding the light.

### (a) TECHNICAL FIELD OF THE INVENTION

The present invention relates generally to a light shielding structure, and more particularly to a light shielding structure that allows for use in private and prevents interference with the electronic devices of other people.

### (b) DESCRIPTION OF THE PRIOR ART

A conventional backlighting display structure generally comprises a backlight module that provides lighting to a screen, a back cover that is arranged backwards of the screen, and a light-transmitting board mounted in and extending through the back cover. The light-transmitting board is generally formed with a pattern of characters or figures so that when the screen is set on, light emitting from the backlight module transmits through the light-transmitting board, this helping save energy and allowing observers to directly view the characters or figures (formed of the light-transmitting board) through which light is projected out so as to improve aesthetics and eye attraction.

However, since light that is projected through the characters or figures (formed of the light-transmitting board) comes from the backlight module, it is not possible to simply alter or control brightness/darkness of the lighting. Thus, it may sometimes get too eye attracting to be used in private. In addition, the light so projected out may inadvertently shine on the eyes of people staying nearby. This may cause unpleasant situations.

### SUMMARY OF THE INVENTION

The primary object of the present invention is to avoid unpleasantness caused by undesired shining of light on the eyes of other people.

Another object of the present invention is to prevent other people from getting aware of an electronic being in operation.

A further object of the present invention is to enable variation of brightness as desired while maintain sharpness and recognizability.

To achieve the above objects, the present invention comprises at least one display device and an outer casing that are mounted to an electronic device. The outer casing is arranged at one side of the display device. The outer casing comprises at least one light transmitting portion mounted therein for light from the display device to transmit therethrough. At least one adjustable light-shielding plate that is operable to change color is arranged between the light transmitting portion and the display device. At least one adjusting device is set on at least one side of the adjustable light-shielding plate and operatively coupled thereto. The adjusting device is provided for operation by a user to selectively change the color of the adjustable light-shielding plate. In the use of the electronic device, the display device emits light and the user may operate the adjusting device to cause the adjustable light-shielding plate to change color for shielding light so as to prevent light from transmitting through the adjustable light-shielding plate and the light transmitting portion. Further, the user may makes the adjustable light-shielding plate in an idle condition and thus not in operation so that light from the display device is allowed to transmit through the adjustable light-shielding plate and the light transmitting portion, whereby the light may be projected from the outer casing. With such a technical solution, the drawbacks of the prior art that the backlighting display structure does not allow for control of brightness/darkness of illumination so as to cause unpleasantness of other people and does not allow for use in private can be effectively overcome and effects of being easy to use, being aesthetics and eye attracting, use in private, and being free of interference with other people can be achieved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view illustrating a preferred embodiment of the present invention.

FIG. 1A is an enlarged view of a circled portion of FIG. 1.

FIG. 2 is a side elevational view of the present invention.

FIG. 2A is an enlarged view of a circled portion of FIG. 2.

FIG. 3 is a schematic view demonstrating light transmission of the present invention.

FIG. 3A is an enlarged view of a circled portion of FIG. 3.

FIG. 4 is a schematic view demonstrating light shielding of the present invention.

FIG. 4A is an enlarged view of a circled portion of FIG. 4.

FIG. 5 is a schematic view illustrating a sideways pushing operation carried out in another embodiment of the present invention.

FIG. 6 is a schematic view illustrating a rotating operation carried out in a further embodiment of the present invention.

FIG. 7 is a schematic view illustrating a chip arranged in yet a further embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

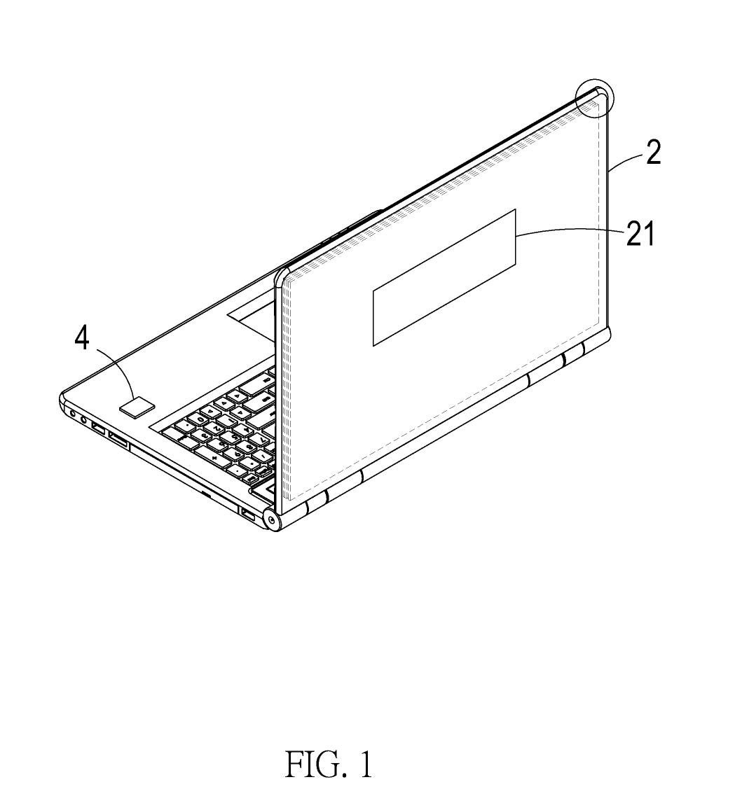

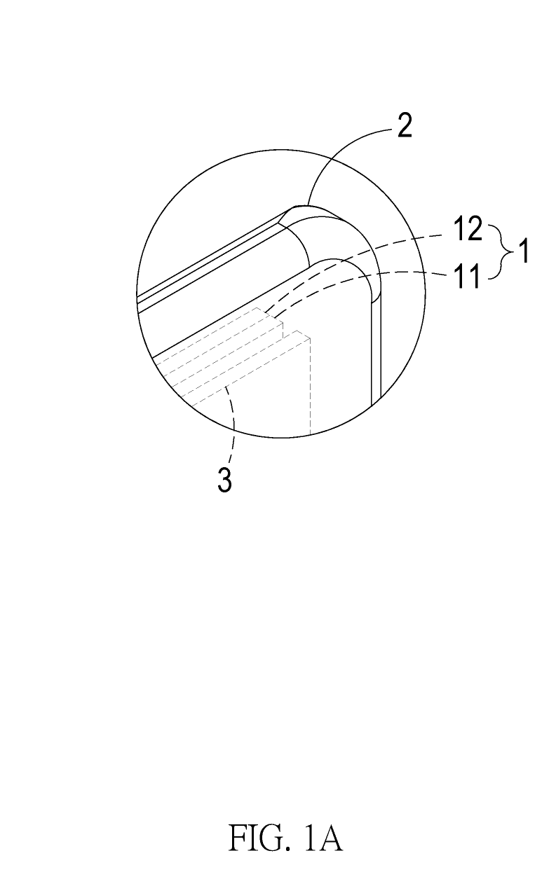

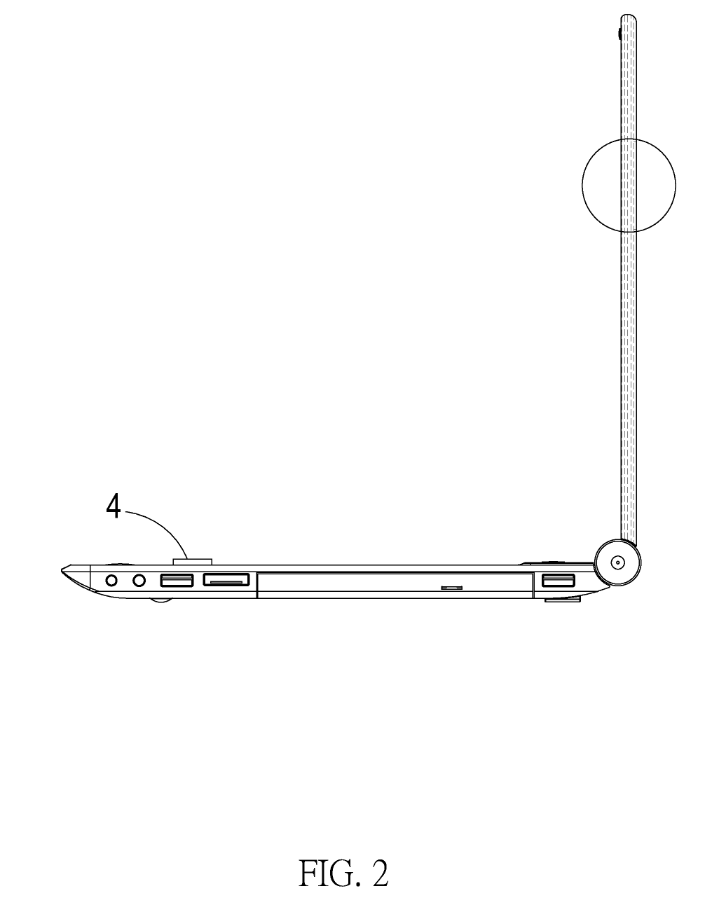

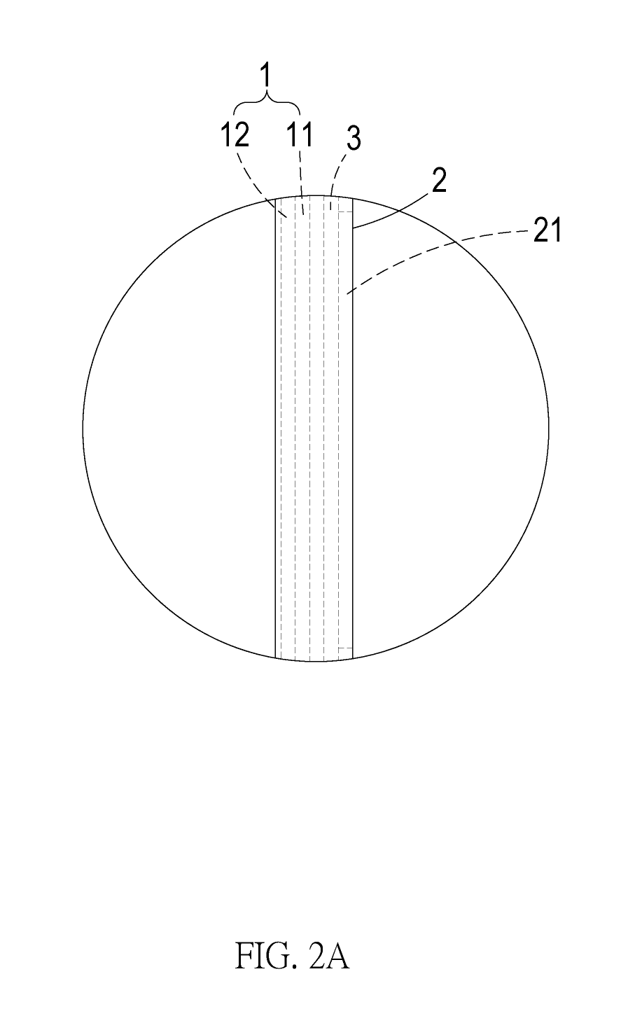

Referring to the illustrations of FIGS. 1 and 2, it is clearly seen that the present invention comprises at least one display device 1 mounted to an electronic device, at least one outer casing 2 mounted to the electronic device, at least one light transmitting portion 21, at least one adjustable light-shielding plate 3, and at least one adjusting device 4, wherein the outer casing 2 is arranged at one side of the display device 1 and the light transmitting portion 21 is mounted on the outer casing 2 to allow light of the display device 1 to transmit therethrough and the light transmitting portion 21 is formed in one of a hollowed configuration, a transparent configuration, and a translucent or partly transparent configuration. Further, the light transmitting portion 21 may be formed to show one of a figure configuration, a character configuration, and a pattern configuration.

The adjustable light-shielding plate 3 is arranged between the display device 1 and the light transmitting portion 21. In a normal state, the adjustable light-shielding plate 3 is set in a transparent configuration and is operable to change color to selectively shield the light that comes from the display device 1 and transmits through the light transmitting portion 21. Further, the display device 1 comprises at least one a backlighting device 11 that is arranged beside the adjustable light-shielding plate 3 and is operable to emit light and at least one observation window device 12 that is arranged at one side of the backlighting device 11 that is distant from and opposite to the adjustable light-shielding plate 3.

The adjusting device 4 is set on at least one side of the adjustable light-shielding plate 3 and is operatively coupled thereto to allow a user to selectively change the color of the adjustable light-shielding plate 3. In the instant embodiment, an example that the adjusting device 4 is mounted on the electronic device and the adjusting device 4 comprising at least one depressible button is illustrated for explanation of the present invention, wherein the depressible button is a pushbutton. This, however, is only one of a number of feasible embodiments of the present invention and the present invention is not limited to such an arrangement.

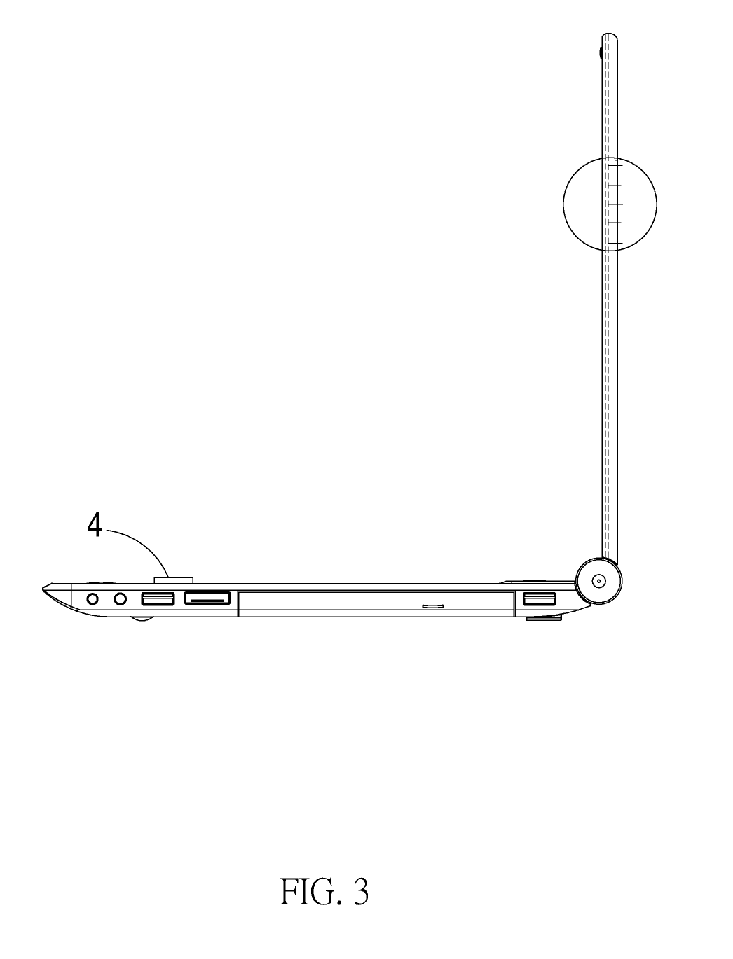

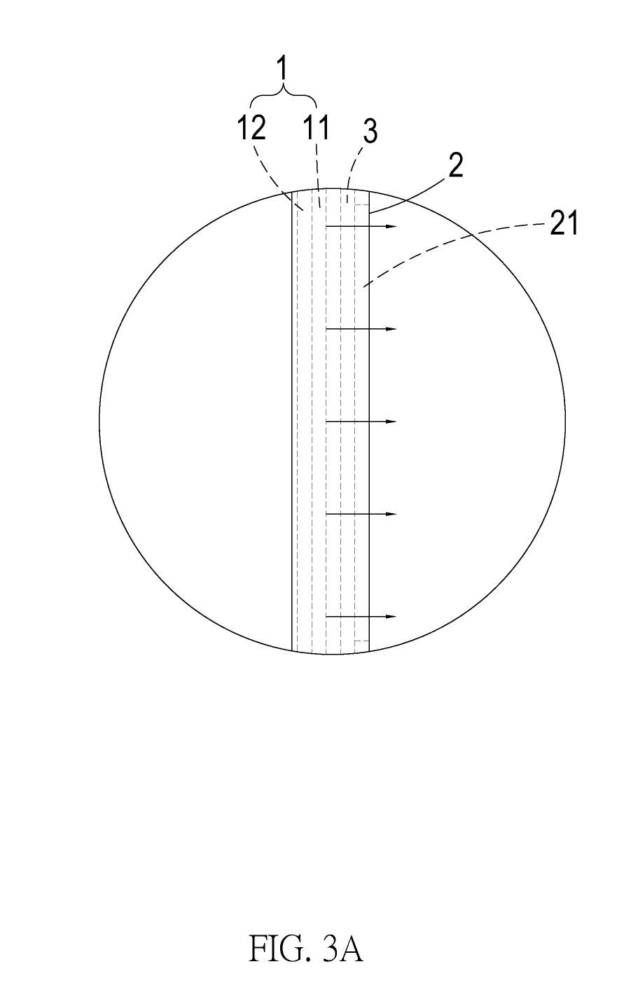

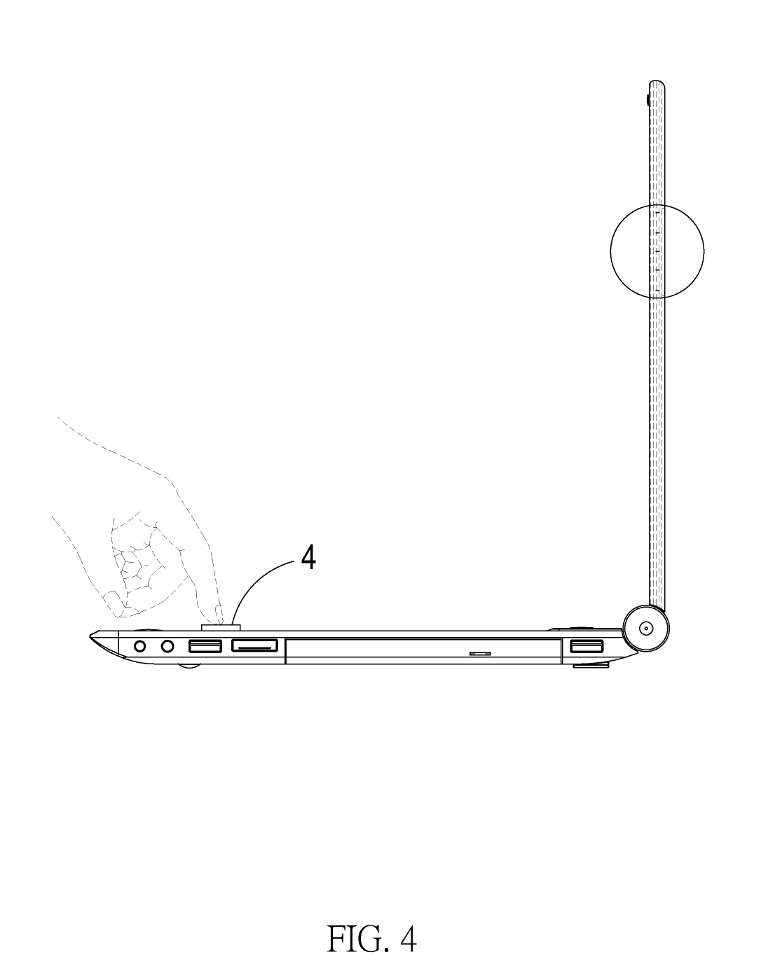

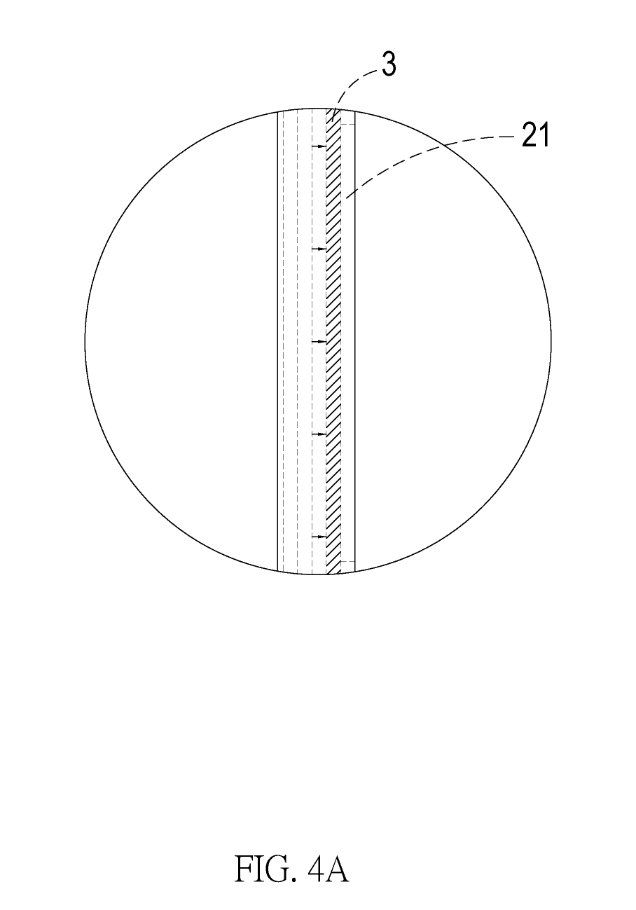

Referring to the illustrations of FIGS. 1-4, it is clearly seen that when the display device 1 is activated, light emitting from the backlighting device 11 travels outwards through the observation window device 12 and may simultaneously and additionally transmit in a direction toward the adjustable light-shielding plate 3 and the light transmitting portion 21. Since the adjustable light-shielding plate 3, when not in operation, is in a transparent configuration, the light from the backlighting device 11 is allowed to directly transmit through the adjustable light-shielding plate 3 and the light transmitting portion 21 to provide an effect of making the outer casing 2 good looking and eye attracting. Further, since this effect is achieved with the light that is originally and primitively, not additionally, generated by the backlighting device 11, there is no need to arrange or provide an additional source of light (or electrical power). As such, energy saving and thus carbon reduction may be achieved.

When the user intends to alter the light transmitting through the light transmitting portion 21, the adjusting device 4 may be operated to cause an operation of the adjustable light-shielding plate 3 to change color so as to partly or completely block or shield the light that was previously transmitting through the light transmitting portion 21. As such, effects of easy operation, use in private, and preventing undesired interference with other persons can be achieved.

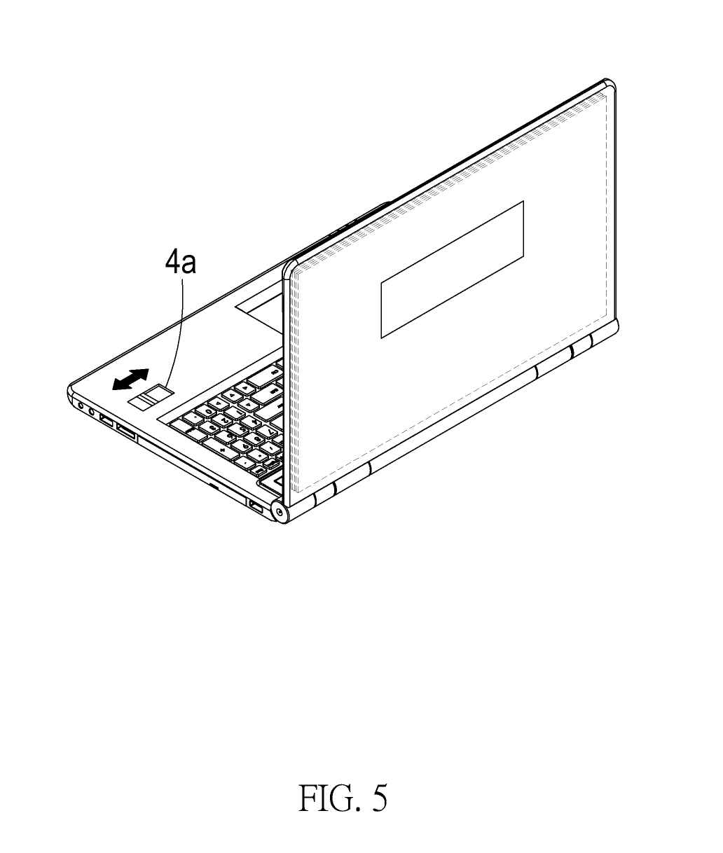

Referring to the illustration of FIG. 5, it is clearly seen that the instant embodiment is generally similar to the previous embodiment and a difference resides in that in the instant embodiment, an adjusting device 4a that comprises at least one sideways-pushable switch is taken as example for illustration. This is provided for demonstrating the diversification of the arrangement of the present invention.

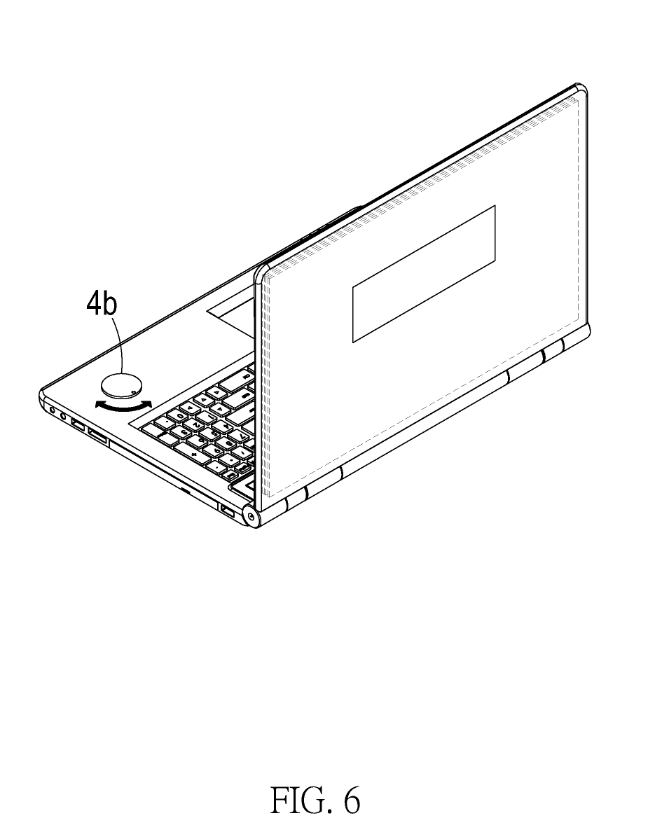

Referring to the illustration of FIG. 6, it is clearly seen that the instant embodiment is generally similar to the previous embodiments and a difference resides in that in the instant embodiment, an adjusting device 4b that comprises at least one rotating switch is taken as example for illustration. This is provided for demonstrating the diversification of the arrangement of the present invention.

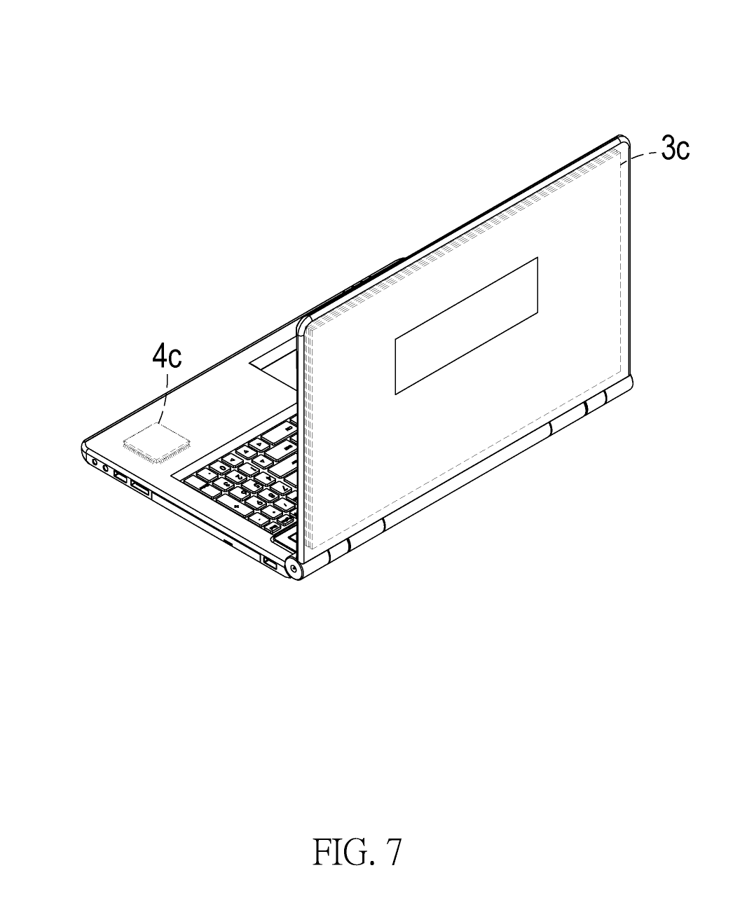

Referring to the illustration of FIG. 7, it is clearly seen that the instant embodiment is generally similar to the previous embodiments and a difference resides in that in the instant embodiment, an adjusting device 4c that is mounted inside the electronic device and comprises at least one adjustment chip is taken as example for illustration, whereby the user may control the adjustable light-shielding plate 3c by means of software. This is provided for demonstrating the diversification of the arrangement of the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A light shielding structure of an electronic device, comprising:
at least one display device that is mounted to an electronic device;
at least one outer casing that is mounted to the electronic device, the outer casing being arranged at one side of the display device;
at least one light transmitting portion, which is mounted on the outer casing to allow light from the display device to transmit therethrough;
at least one adjustable light-shielding plate, which is arranged between the display device and the light transmitting portion, the adjustable light-shielding plate being operable to change color in order to selectively shield the light from the display device and transmitting through the light transmitting portion; and
at least one adjusting device, which is set on at least one side of the adjustable light-shielding plate and is operatively coupled thereto to allow for selective change of the color of the adjustable light-shielding plate.

2. The light shielding structure of the electronic device according to claim 1, wherein the display device comprises at least one backlighting device arranged beside the adjustable light-shielding plate for emitting light and at least one observation window device arranged at one side of the backlighting device that is distant from and opposite to the adjustable light-shielding plate.

3. The light shielding structure of the electronic device according to claim 1, wherein the light transmitting portion is formed in one of a hollowed configuration, a transparent configuration, and a translucent configuration.

4. The light shielding structure of the electronic device according to claim 1, wherein the light transmitting portion is formed in one of a figure configuration, a character configuration, and a pattern configuration.

5. The light shielding structure of the electronic device according to claim 1, wherein the adjusting device is mounted on the electronic device and the adjusting device comprises at least one depressible button.

6. The light shielding structure of the electronic device according to claim 5, wherein the depressible button is a pushbutton.

7. The light shielding structure of the electronic device according to claim 1, wherein the adjusting device is mounted on the electronic device and the adjusting device comprises at least one sideways pushable switch.

8. The light shielding structure of the electronic device according to claim 1, wherein the adjusting device is mounted on the electronic device and the adjusting device comprises at least one rotating switch.

9. The light shielding structure of the electronic device according to claim 1, wherein the adjusting device is mounted inside the electronic device and the adjusting device comprises at least one adjustment chip.
